(19) United States
(12) Patent Application Publication
(10) Pub. No.: US 2022/0040645 A1
(43) Pub. Date: Feb. 10, 2022

(54) SELECTIVELY PERMEABLE GRAPHENE OXIDE MEMBRANE

(71) Applicant: NITTO DENKO CORPORATION, Osaka (JP)

(72) Inventors: Shijun Zheng, San Diego, CA (US); Weiping LIN, Carlsbad, CA (US); Isamu Kitahara, San Diego, CA (US); Peng Wang, San Diego, CA (US)

(21) Appl. No.: 17/275,638

(22) PCT Filed: Sep. 16, 2019
(86) PCT No.: PCT/US2019/051255

§ 371 Date: Mar. 11, 2021

Related U.S. Application Data
(60) Provisional application No. 62/732,866, filed on Sep. 18, 2018.

(51) Int. Cl. B01D 71/38; B01D 69/12; B01D 71/02; B01D 71/48; B01D 53/14; B01D 69/10

(52) U.S. Cl. CPC B01D 71/38; B01D 69/12; B01D 71/024; B01D 2323/30; B01D 53/14; B01D 69/10; B01D 2257/80; B01D 71/48

(57) ABSTRACT

Described herein is a crosslinked graphene and biopolymer (e.g. lignin) based composite membrane that provides selective resistance for gases while providing water vapor permeability. Methods for making such membranes, and methods of using the membranes for dehydrating mixtures, are also described.

### CROSS-REFERENCE TO RELATED APPLICATIONS

This application claims the benefit of U.S. Provisional Application No. 62/732,866, filed Sep. 18, 2018, which is incorporated by reference in its entirety.

### FIELD

The present embodiments are related to polymeric membranes, including membranes comprising graphene materials, for applications such as removing water or water vapor from air or other gas streams and energy recovery ventilation (ERV).

### BACKGROUND

The presence of a high moisture level in the air may make people uncomfortable, and may cause serious health issues by promoting growth of mold, fungus, and dust mites. In manufacturing and storage facilities, high humidity environments may accelerate product degradation, powder agglomeration, seed germination, corrosion, and other undesired effects, which is a concern for chemical, pharmaceutical, food and electronic industries. One of the conventional methods to dehydrate air includes passing wet air through hygroscopic agents, such as glycol, silica gel, molecular sieves, calcium chloride, or phosphorus pentoxide. This method has many disadvantages; for example, the drying agent is carried over in a dry air stream, and the drying agent also requires replacement or regeneration over time. These factors make this conventional dehydration process costly and time consuming. Another conventional method of dehydration of air is a cryogenic method involving compressing and cooling the wet air to condense moisture followed by removing the condensed water. This method, however, is highly energy consuming.

Compared with the conventional dehydration or dehumidification technologies described above, membrane-based gas dehumidification technology has distinct technical and economic advantages. These advantages include low installation cost, easy operation, high energy efficiency, low process cost, and high processing capacity. This technology has been successfully applied in dehydration of nitrogen, oxygen, and compressed air. For energy recovery ventilator (ERV) applications, such as inside buildings, it is desirable to provide fresh air from outside. Energy is required to cool and dehumidify the fresh air, especially in hot and humid climates where the outside air is much hotter and has more moisture than the air inside the building. The amount of energy required for heating or cooling and dehumidification can be reduced by transferring heat and moisture between the exhausting air and the incoming fresh air through an ERV system. The ERV system comprises a membrane which separates the exhausting air and the incoming fresh air physically but allows heat and moisture exchange. The required key characteristics of the ERV membrane include: (1) low permeability of air and gases other than water vapor; (2) high permeability of water vapor for effective transfer of moisture between the incoming and the outgoing air stream while blocking the passage of other gases; and (3) high thermal conductivity for effective heat transfer.

There is a need for membranes with high permeability of water vapor and low permeability of air for ERV applications.

### SUMMARY

This disclosure relates to a graphene oxide membrane composition suitable for dehydration applications. The graphene oxide compositions described herein may be useful for dehydration of a moist gas by having a high moisture permeability and a low gas permeability. The graphene oxide membrane composition may be prepared by using one or more water soluble crosslinkers such as a lignin. Methods of efficiently and economically making these graphene oxide membrane compositions are also described. Water can be used as a solvent in preparing these graphene oxide membrane compositions, which makes the membrane preparation process more environmentally friendly and more cost effective.

Described herein is a method for dehydrating a gas. The method can comprise applying a first gas to the dehydration membrane, wherein the dehydration membrane comprises a porous support and a composite coated on the porous support. The dehydration membrane has a first side and a second side, wherein the gas to be dehydrated is introduced to the first side of the membrane. The composite may comprise a crosslinked graphene oxide compound, wherein the crosslinked graphene oxide compound is formed by reacting a mixture comprising a graphene oxide compound and a crosslinker comprising a lignin. Some embodiments further comprise polyvinyl alcohol as a crosslinker. The dehydration membrane may allow water vapor to pass through to the second side, while being impermeable to the gas, thus generating a second gas that has lower water vapor content than the first gas. In some cases, the method further comprises a sweep gas on the second side of the membrane that removes permeated water vapor.

In some embodiments, the graphene oxide compound can comprise graphene oxide, reduced-graphene oxide, functionalized graphene oxide, or functionalized and reduced-graphene oxide. In some embodiments, the graphene oxide compound can be graphene oxide. In some embodiments, the lignin can comprise sodium lignosulfonate, calcium lignosulfonate, magnesium lignosulfonate, and/or potassium lignosulfonate. In some embodiments, the crosslinker can further comprise a polyvinyl alcohol. In some embodiments, the weight ratio of polyvinyl alcohol to lignin can be about 5 or less. In some embodiments, the composite can further comprise a borate salt. In some embodiments, the borate salt can comprise K₂B₄O₇, Li₂B₄O₂, and/or Na₂B₄O₂. In some embodiments, the borate salt can be about 20 wt % or less of the composite. In some embodiments, the composite can further comprise CaCl₂). In some embodiments, the CaCl₂) can be about 5 wt % or less of the composite. In some embodiments, the composite can further comprise silica nanoparticles. In some embodiments, the silica nanoparticles can be about 10 wt % or less of the composite. In some embodiments, the average size of the silica nanoparticles can be about 5 nm to about 200 nm. In some embodiments, the porous support can be a non-woven fabric. In some embodiments, the porous support can comprise polyamide, polyimide, polyvinylidene fluoride, polyethylene, polypropylene, polyethylene terephthalate, polysulfone, and/or polyether sulfone. In some embodiments, the porous support can comprise polyethylene terephthalate. In some embodiments, the porous support can have a thickness of about 10 nm to about 2000 nm. In some embodiments, the weight ratio of the crosslinker to the graphene oxide compound can be about 2 to about 6. In some embodiments, the composite can be a layer having a thickness of about 50 nm to about 2000 nm. In some embodiments, the composite can further contain water.

### BRIEF DESCRIPTION OF THE DRAWINGS

FIG. 1 is a depiction of a possible embodiment of a dehydration membrane without a protective coating.

FIG. 2 is a depiction a possible embodiment of a dehydration membrane with a protective coating.

FIG. 3 is a depiction of a possible embodiment for the method of making a dehydration membrane.

FIG. 4 is a diagram depicting the experimental setup for the water vapor permeability and gas leakage testing.

FIG. 5 is a chart showing mechanical performance of various membrane embodiments.

### DETAILED DESCRIPTION

A selectively permeable membrane includes a membrane that is relatively permeable to one material and relatively impermeable to another material. For example, a membrane may be relatively permeable to water vapor and relatively impermeable to gases such as oxygen and/or nitrogen. The ratio of permeability for different materials may be useful in describing their selective permeability.

The present disclosure relates to selectively permeable membranes that may serve as dehydration membranes where a high moisture permeability and a low gas permeability may be useful to effect dehydration of a gas. The membranes described herein may be suitable in the dehumidification of air, oxygen, nitrogen, hydrogen, methane, propylene, carbon dioxide, and natural gas. In some embodiments, a membrane including a moisture permeable graphene oxide-biopolymer composition may have high moisture/gas selectivity. These embodiments may improve the energy efficiency of a dehydration membrane and/or an ERV system, as well as improve separation efficiency.

### Dehydration Membrane

Described herein are membranes comprising a highly selective hydrophilic graphene oxide compound based composite material with high water vapor permeability, low gas permeability, and high mechanical and chemical stability. These membranes may be useful in applications where a dry gas or a gas with low water vapor content is desired.

In some embodiments, the membrane may be a dehydration membrane. In some embodiments, the membrane may be an air dehydration membrane. In some embodiments, the membrane may be a gas separation membrane. In some embodiments, a moisture permeable-and/or-gas impermeable barrier element containing a graphene material, e.g., graphene oxide (GO), may provide desired selective gas, fluid, and/or vapor permeability resistance. In some embodiments, the selectively permeable element may comprise multiple layers, where at least one layer is a layer containing a graphene oxide compound. It is believed that a crosslinked GO layer, with graphene oxide's potential hydrophilicity and selective permeability, may provide a membrane having broad applications where high water vapor permeability and high selectivity of permeability is important. In addition, these selectively permeable membranes may also be prepared using water as a solvent, which can make the manufacturing process much more environmentally friendly and cost effective.

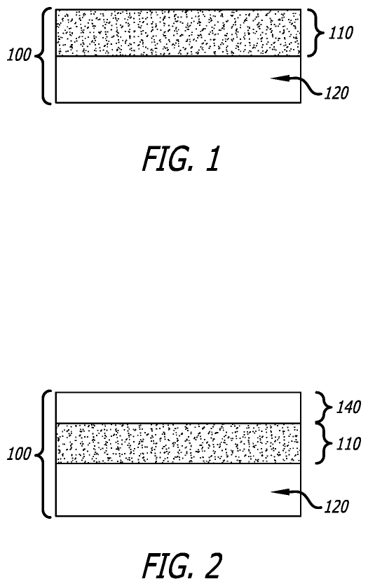

Generally, a dehydration membrane comprises a porous support and a composite coated onto the support. For example, as depicted in FIG. 1, a selectively permeable membrane, such as membrane 100 can include porous support, such as support 120. A composite, such as composite 110, is coated onto the porous support 120.

In some embodiments, the porous support may be sandwiched between two composite layers.

Additional filtering layers may also be present, such as a salt rejection layer, etc. In addition, the membrane can also include a protective layer. In some embodiments, the protective layer can comprise a hydrophilic polymer. In some embodiments, the fluid, such as a liquid or gas, passing through the membrane travels through all the components regardless of whether they are in physical communication or their order of arrangement.

A protective layer may be placed in any position that helps to protect the selectively permeable membrane, such as a water permeable membrane, from harsh environments, such as compounds with may deteriorate the layers, radiation, such as ultraviolet radiation, extreme temperatures, etc. For example, as shown in FIG. 2, a selectively permeable membrane, such as membrane 100, may further comprise protective coating, such as protective coating 140, which is disposed on, or over, composite 110.

In some embodiments, the water vapor passing through the membrane travels through all the components regardless of whether they are in physical communication or their order of arrangement.

A dehydration or water permeable membrane, such as membranes described herein, can be used to remove moisture from a gas stream. In some embodiments, a membrane may be disposed between a first gas component and a second gas component such that the components are in fluid communication through the membrane. In some embodiments, the first gas may contain a feed gas upstream of or at the permeable membrane.

In some embodiments, the membrane can selectively allow water vapor to pass through while limiting or preventing other gases or a gas mixture, such as nitrogen, oxygen, and/or air, from passing through. In some embodiments, the gas mixture upstream of the membrane can comprise a mixture of water vapor and other gases. In some embodiments, the gas mixture downstream of the membrane may contain purified or dehydrated gases, e.g., on the first side of the membrane. In some embodiments, the permeated mixture on the second side of the membrane downstream of the membrane may contain hydrated gases with increased water vapor. In some embodiments, as a result of the layers, the membrane may provide a durable dehydration system that can be selectively permeable to water vapor, and less permeable to other gases. In some embodiments, as a result of the layers, the membrane may provide a durable dehydration system that may effectively dehydrate gases.

In some embodiments, the membrane can be highly moisture permeable. In some embodiments, the membrane may be a dehydration membrane. In some embodiments, the membrane may be an air dehydration membrane. In some embodiments, the membrane may be a gas separation membrane. In some embodiments, a membrane that is a moisture permeable and/or gas impermeable barrier membrane containing graphene material, e.g., graphene oxide, may provide desired selectivity between water vapor and other gases. In some embodiments, the membrane, e.g., a layer containing graphene oxide material, can allow the water vapor in the first gas to pass through the dehydration membrane, generating a second gas that has lower water vapor content than the first gas. In some embodiments, the selectively permeable membrane may comprise multiple layers, where at least one layer is a layer containing a graphene oxide material allowing the water vapor to pass through the dehydration membrane and generating a second gas that has lower water vapor content than the first gas.

In some embodiments, the moisture permeability may be measured by water vapor transfer rate. In some embodiments, the membrane exhibits a normalized water vapor flow rate of about 500-2000 g/m²/day; about 1000-2000 g/m²/day, about 1000-1500 g/m²/day, about 1500-2000 g/m²/day, about 1000-1700 g/m²/day; about 1200-1500 g/m²/day; about 1300-1500 g/m²/day, at least about 500 g/m²/day, about 500-1000 g/m²/day, about 500-750 g/m²/day, about 750-1000 g/m²/day, about 600-800 g/m²/day, about 800-1000 g/m²/day, about 1000 g/m²/day, about 1200 g/m²/day, about 1300 g/m²/day, or any normalized volumetric water vapor flow rate in a range bounded by any of these values. A suitable method for determining moisture (water vapor) transfer rates is ASTM E96. In some embodiments, a membrane may be selectively permeable. In some embodiments, the selectively permeable membrane may comprise multiple layers, wherein at least one layer contains a composite which is a product of a reaction of a mixture comprising a graphene oxide compound and a crosslinker, for example, a lignan.

### Porous Support

A porous support may be any suitable material and in any suitable form upon which a layer, such as a layer of the composite, may be deposited or disposed. In some embodiments, the porous support can comprise hollow fibers or porous material. In some embodiments, the porous support may comprise a porous material, such as a polymer or a hollow fiber. Some porous supports can comprise a non-woven fabric. In some embodiments, the polymer may be polyamide (Nylon), polyimide (PI), polyvinylidene fluoride (PVDF), polyethylene (PE), stretched PE, polypropylene (PP), stretched polypropylene, polyethylene terephthalate (PET), polysulfone (PSF), polyether sulfone (PES), cellulose, cellulose acetate, polyacrylonitrile (e.g. PA200), or a combination thereof. In some embodiments, the polymer can comprise PET.

### Composite Comprising GO

The membranes described herein can comprise a composite that coats the porous support. In some embodiments, the composite is formed by creating and/or heating a mixture to form crosslinking covalent bonds. The mixture that forms the composite can comprise a graphene oxide compound and a biopolymer, such as a lignin. Some examples include polyvinyl alcohol as a second crosslinker in addition to the graphene oxide compound and the biopolymer. In some embodiments, an additive can be present in the composite reaction mixture. In some embodiments, the additive comprises CaCl₂, a borate salt, silica nanoparticles, or any combination thereof. The reaction mixture may form covalent bonds, such as crosslinking bonds, between the constituents of the composite (e.g., graphene oxide compound, the lignin, polyvinyl alcohol, and/or additives). For example, a platelet of a graphene oxide compound may be covalently bound to another platelet of a graphene oxide compound. Alternatively, a graphene oxide compound or a platelet thereof may be covalently bound to a crosslinker (such as a lignin or polyvinyl alcohol). In some embodiments, a graphene oxide compound may be covalently bound to an additive. A crosslinker (such as a lignin or polyvinyl alcohol) may be bound to another crosslinker, and/or a crosslinker (such as a lignin or polyvinyl alcohol) may be bonded to an additive. In some embodiments, any combination of graphene oxide compound, crosslinker (such as a lignin or polyvinyl alcohol), and additive can be covalently bound to form a composite matrix.

In some embodiments, the graphene oxide in a composite layer can have an interlayer distance or d-spacing of about 0.5-3 nm, about 0.6-2 nm, about 0.7-1.8 nm, about 0.8-1.7 nm, about 0.9-1.7 nm, about 1-1.2 nm, about 1.2-2 nm, abut 1.2-1.5 nm, about 1.5-2.3 nm, about 1.5-1.61 nm, about 1.6-1.8 nm, about 1.8-2 nm, about 2-2.5 nm, about 2.5-3 nm, about 1.61 nm, about 1.67 nm, about 1.55 nm or any distance in a range bounded by any of these values. The d-spacing can be determined by x-ray powder diffraction (XRD).

The composite layer can have any suitable thickness. For example, some graphene oxide-based composite layers may have a thickness ranging from about 5-2000 nm, about 50-2000 nm, about 5-1000 nm, about 1000-2000 nm, about 10-500 nm, about 50-500 nm, about 500-1000 nm, about 50-500 nm, about 50-400 nm, about 20-1000 nm, about 5-40 nm, about 10-30 nm, about 20-60 nm, about 50-100 nm, about 100-300 nm, about 70-120 nm, about 120-170 nm, about 150-200 nm, about 180-220 nm, about 200-250 nm, about 200-300 nm, about 220-270 nm, about 250-300 nm, about 280-320 nm, about 300-400 nm, about 330-480 nm, about 400-600 nm, about 600-800 nm, about 800-1000 nm, about 50-500 nm, about 100-400 nm, about 100 nm, about 150 nm, about 200 nm, about 225 nm, about 250 nm, about 300 nm, about 350 nm, about 400 nm, or any thickness in a range bounded by any of these values. Ranges above that encompass the following thicknesses are of particular interest: about 100 nm, about 200 nm, about 225 nm, and about 300 nm.

In general, graphene-based materials have many attractive properties, such as a 2-dimensional sheet-like structure with extraordinarily high mechanical strength and nanometer scale thickness. Graphene oxide (GO) is an exfoliated oxidation product of graphite that can be mass produced at low cost. With its high degree of oxidation, graphene oxide has high water permeability and may be modified using a variety of functional groups, such as amines or alcohols, to form a large assortment of membrane structures. Unlike traditional membranes, where the water is transported through the pores of the material, in graphene oxide membranes, the transportation of water can be between the interlayer spaces. Graphene oxide's capillary effect can result in long water slip lengths that offer a fast water transportation rate. Additionally, the membrane's selectivity and water flux can be controlled by adjusting the interlayer distance of graphene sheets, or by the utilization of different crosslinking functionality.

In the membranes of the present disclosure, a graphene oxide compound includes an optionally substituted graphene oxide. In some embodiments, the optionally substituted graphene oxide may contain a graphene oxide compound which has been chemically modified, or functionalized. A modified graphene oxide compound may be any graphene oxide compound that has been chemically modified, or functionalized. In some embodiments, the graphene oxide can be optionally substituted.

Unless otherwise indicated, when a compound or a chemical structure, such as graphene oxide, is referred to as being “optionally substituted,” it includes a compound or a chemical structure that either has no substituents (i.e., unsubstituted), or has one or more substituents (i.e., substituted). The term “substituent” has the broadest meaning known in the art and includes a moiety that replaces one or more hydrogen atoms attached to a parent compound or structure. In some embodiments, a substituent may be any type of group that may be present on a structure of an organic or an inorganic compound, which may have a molecular weight (e.g., the sum of the atomic masses of the atoms of the substituent) of 15-50 g/mol, 15-100 g/mol, 15-150 g/mol, 15-200 g/mol, 15-300 g/mol, or 15-500 g/mol. In some embodiments, a substituent comprises, or consists of: 0-30, 0-20, 0-10, or 0-5 carbon atoms; and 0-30, 0-20, 0-10, or 0-5 heteroatoms, wherein each heteroatom may independently be: N, O, S, Si, F, Cl, Br, or I; provided that the substituent includes at least one C, N, O, S, Si, F, CI, Br, or I atom. Examples of substituents include, but are not limited to, alkyl, alkenyl, alkynyl, heteroalkyl, heteroalkenyl, heteroalkynyl, aryl, heteroaryl, hydroxy, alkoxy, aryloxy, acyl, acyloxy, alkylcarboxylate, thiol, alkylthio, cyano, halo, thiocarbonyl, O-carbamyl, N-carbamyl, O-thiocarbamyl, N-thiocarbamyl, C-amido, N-amido, S-sulfonamido, N-sulfonamido, isocyanato, thiocyanato, isothiocyanato, nitro, silyl, sulfenyl, sulfinyl, sulfonyl, haloalkyl, haloalkoxyl, trihalomethanesulfonyl, trihalomethanesulfonamido, amino, etc.

For convenience, the term “molecular weight” is used with respect to a moiety or part of a molecule to indicate the sum of the atomic masses of the atoms in the moiety or part of a molecule, even though it may not be a complete molecule.

Functionalized graphene oxide is a graphene oxide compound that includes one or more functional groups not present in graphene oxide, such as functional groups that are not OH, COOH, or an epoxide group directly attached to a carbon atom (or 2 carbon atoms in the case of an epoxide) of the graphene base. Examples of functional groups that may be present in functionalized graphene include halogen, alkene, alkyne, cyano, ester, amide, or amine.

In some embodiments, at least about 99%, at least about 95%, at least about 90%, at least about 80%, at least about 70%, at least about 60%, at least about 50%, at least about 40%, at least about 30%, at least about 20%, at least about 10%, or at least about 5% of the graphene molecules in a graphene oxide compound may be oxidized or functionalized. In some embodiments, the graphene oxide compound is graphene oxide, which may provide selective permeability for gases, fluids, and/or vapors. In some embodiments, the graphene oxide compound can also include reduced graphene oxide. In some embodiments, the graphene oxide compound can be graphene oxide, reduced-graphene oxide, functionalized graphene oxide, or functionalized and reduced-graphene oxide. In some embodiments, the graphene oxide compound is graphene oxide that is not functionalized.

It is believed that there may be a large number (^{˜}30%) of epoxy groups on graphene oxide, which may be readily reactive with hydroxyl groups and other nucleophilic polymers and additives at elevated temperatures. It is also believed that graphene oxide sheets have an extraordinarily high aspect ratio which provides a large available gas/water diffusion surface as compared to other materials, and it has the ability to decrease the effective pore diameter of any substrate supporting material to minimize contaminant infusion while retaining flux rates. It is also believed that the epoxy or hydroxyl groups present on the graphene oxide compound increase the hydrophilicity of the graphene oxide composite, and thus contributes to the increase in water vapor permeability and selectivity of the membrane.

In some embodiments, the optionally substituted graphene oxide compound may be in the form of sheets, planes or flakes. In some embodiments, the graphene material may have a surface area of about 100-5000 m²/g, about 150-4000 m²/g, about 200-1000 m²/g, about 500-1000 m²/g, about 1000-2500 m²/g, about 2000-3000 m²/g, about 100-500 m²/g, about 400-500 m²/g, or any surface area in a range bounded by any of these values.

In some embodiments, the graphene oxide compound may comprise platelets having 1, 2, or 3 dimensions with size of each dimension independently in the nanometer to micron range. In some embodiments, the graphene may have a platelet size in any one of the dimensions, or may have a square root of the area of the largest surface of the platelet, of about 0.05-100 μm, about 0.05-50 μm, about 0.1-50 μm, about 0.5-10 μm, about 1-5 μm, about 0.1-2 μm, about 1-3 μm, about 2-4 μm, about 3-5 μm, about 4-6 μm, about 5-7 μm, about 6-8 μm, about 7-10 μm, about 10-15 μm, about 15-20 μm, about 20-50 μm, about 50-100 μm, about 60-80 μm, about 50-60 μm, about 25-50 μm, or any platelet size in a range bounded by any of these values.

In some embodiments, the graphene oxide compound can comprise at least 70%, at least 75%, at least 80%, at least 85%, at least 90%, at least 95%, at least 97%, or at least 99% of the graphene oxide compound having a molecular weight of about 5,000-200,000 Daltons.

The composite may contain any suitable amount of graphene oxide compound, such as about 4-80 wt %, about 4-75 wt %, about 5-70 wt %, about 7-65 wt %, about 7-60 wt %, about 7.5-55 wt %, about 8-50 wt %, about 8.5-50 wt %, about 15-50 wt %, about 1-5 wt %, about 3-8 wt %, about 5-10 wt %, about 7-12 wt %, about 10-15 wt %, about 12-17 wt %, about 12.8-13.3 wt %, about 13-13.5 wt %, about 13.2-13.7 wt %, about 13.4-13.9 wt %, about 13.6-14.1 wt %, about 13.8-14.3 wt %, about 14-14.5 wt %, about 14.2-14.7 wt %, about 14.4-14.9 wt %, about 14.6-15.1 wt %, about 14.8-15.3 wt %, about 15-15.5 wt %, about 15.2-15.7 wt %, about 15.4-15.9 wt %, about 15.6-16.1 wt %, about 12-14 wt %, about 13-15 wt %, about 14-16 wt %, about 15-17 wt %, about 16-18 wt %, about 15-20 wt %, about 17-23 wt %, about 20-25 wt %, about 23-28 wt %, about 25-30 wt %, about 30-40 wt %, about 35-45 wt %, about 40-50 wt %, about 45-55 wt %, or about 50-70 wt %, or any percentage in a range bounded by any of these values. Ranges above that encompass the following weight percentages of the graphene oxide compound, such as graphene oxide, are of particular interest: about 13.2 wt %, about 15.0 wt %, and about 15.3 wt %.

### Crosslinker

In some embodiments, the composite comprises a graphene oxide compound and a polymer. In some cases, the polymer is a crosslinking polymer. The crosslinking polymer may comprise a biopolymer such as a lignin. In some embodiments, the composite may further comprise a second crosslinker, such as a polyvinyl alcohol.

In some embodiments, the crosslinker may be a plant-based polymer such as a lignin. Lignins are crosslinked phenolic polymers, such as a polymer comprising crosslinked paracoumaryl alcohol, coniferyl alcohol, sinapyl alcohol, or a combination thereof. In some examples, the crosslinked phenolic polymers may be derivatives and/or salts of these polymers. For example, a lignin can be sulfonated, such as a lignosulfonate. In some embodiments, the lignosulfonate can comprise a salt such as sodium lignosulfonate (CAS: 8061-51-6), calcium lignosulfonate, magnesium lignosulfonate, potassium lignosulfonate, etc. In some embodiments, the crosslinker comprises sodium lignosulfonate.

In some embodiments, the weight average molecular weight of lignosulfonate may be about 20-40 kDa, about 30-50 kDa, about 40-60 kDa, about 50-70 kDa, about 60-80 kDa, about 70-90 kDa, about 80-100 kDa, about 90-110 kDa, about 100-120 kDa, about 110-130 kDa, about 120-140 kDa about 52,000 Da, or any molecular weight in a range bounded by any of these values.

In some embodiments, the number average molecular weight of lignosulfonate may be about 2-7 kDa, about 4-9 kDa, about 6-11 kDa, about 8-13 kDa, about 7,000 kDa, or any molecular weight in a range bounded by any of these values.

The lignin, such as a lignosulfonate, may be present in any suitable amount. For example, with respect to the total weight of the composite, the lignin may be present in an amount of about 0.1-90 wt %, about 0.1-10 wt %, about 5-15 wt %, about 10-20%, about 18-22 wt %, about 20-24 wt %, about 22-26 wt %, about 24-28 wt %, about 26-30 wt %, about 28-32 wt %, about 30-34 wt %, about 32-36 wt %, about 34-38 wt %, about 36-40 wt %, about 38-42 wt %, about 40-50 wt %, about 45-55 wt %, about 50-54 wt %, about 52-56 wt %, about 54-58 wt %, about 56-60 wt %, about 58-62 wt %, about 60-64 wt %, about 62-66 wt %, about 64-68 wt %, about 66-70 wt %, about 68-72 wt %, about 70-74 wt %, about 72-76 wt %, about 74-78 wt %, about 76-80 wt %, about 78-82 wt %, about 80-90 wt %, or any weight percentage in a range bounded by any of these values. Any of the above ranges which encompass any of the following percentages of the lignin, such as a lignosulfonate, are of particular interest: 25 wt %, 37 wt %, 38 wt %, 57 wt %, 72 wt %, 73 wt %, 74 wt %, 75 wt %, 76 wt %, and 77 wt %.

In some composites, the graphene oxide compound and lignin may be bonded to form a network of crosslinkages or a material matrix composite. The bonding can be physical or chemical. The bonding can be direct or indirect; such as through a linking group that covalently connects the graphene oxide to the lignin.

In some membranes, the crosslinker can further comprise a polyvinyl alcohol. In some embodiments, the weight ratio of polyvinyl alcohol to a biopolymer, e.g., a lignin, can be in range of about 0-10 (10 mg of polyvinyl alcohol and 1 mg of lignin is a ratio of 10), about 0.01-0.05, about 0.05-0.1, about 0.1-2, about 0.1-0.3, about 0.2-0.4, about 0.3-0.5, about 0.4-0.6, about 0.5-1, about 0.5-0.7, about 0.6-1.1, about 0.6-0.8, about 0.7-0.9, about 0.8-1.2, 0.8-1, about 0.9-1.1, about 1-2, about 1-3, about 1-1.2, about 1.1-1.3, about 1.2-1.4, about 1.3-1.5, about 1.5-2, about 1.5-1.7, about 1.6-1.8, about 1.7-1.9, about 1.8-2, about 1, about 0.33, about 0.5, about 0.05, or about 0.2-1.5.

The molecular weight of the polyvinyl alcohol (PVA) may be about 100-1,000,000 Daltons (Da), about 10,000-500,000 Da, about 10,000-50,000 Da, about 50,000-100,000 Da, about 70,000-120,000 Da, about 80,000-130,000 Da, about 90,000-140,000 Da, about 90,000-100,000 Da, about 95,000-100,000 Da, about 89,000-98,000 Da, about 89,000 Da, about 98,000 Da, or any molecular weight in a range bounded by any of these values.

In some embodiments, the weight percentage of polyvinyl alcohol, based on the total weight of the composite, is about 0.1-5 wt %, about 2-5 wt %, about 3-6 wt %, about 4-10%, about 8-15 wt %, about 12-20 wt %, about 18-22 wt %, about 20-24 wt %, about 22-26 wt %, about 24-28 wt %, about 26-30 wt %, about 28-32 wt %, about 30-34 wt %, about 32-36 wt %, about 34-38 wt %, about 36-40 wt %, about 38-42 wt %, about 40-50 wt %, about 45-55 wt %, about 50-54 wt %, about 52-56 wt %, about 55-65 wt %, about 60-70 wt %, about 65-75%, about 70-74 wt %, about 72-76 wt %, about 74-78 wt %, about 76-80 wt %, about 78-82 wt %, or about 80-90 wt %, or any weight percentage in a range bounded by any of these values. Any of the above ranges which encompass any of the following percentages of polyvinyl alcohol, are of particular interest: 4 wt %, 19 wt %, 25 wt %, 37 wt %, 38 wt %, 50 wt %, and 77 wt %.

In some embodiments, the weight ratio of the crosslinker(s) to GO (weight ratio=weight of crosslinker(s)÷ weight of graphene oxide) can be about 0.25-15, about 0.2-13, about 0.3-12, about 0.5-10, about 3-9, about 4-8, about 4.5-6, about 4-4.2, about 4.2-4.4, about 4.4-4.6, about 4.6-4.8, about 4.8-5, about 5-5.2, about 5.2-5.4, about 5.4-5.6, about 5.6-5.8, about 5.8-6, such as about 4.7, about 4.9, about 5 (for example 5 mg of crosslinker and 1 mg of optionally substituted graphene oxide), or any ratio in a range bounded by any of these values. In some membranes, the weight ratio of crosslinker to graphene oxide can be in a range of 2-6.

It is believed that crosslinking the graphene oxide can also enhance the graphene oxide composite's mechanical strength and water permeable properties by creating strong chemical bonding and wide channels between graphene platelets to allow water to pass through the platelets easily, while increasing the mechanical strength between the moieties within the composite. In some embodiments, at least about 1%, about 5%, about 10%, about 20%, about 30%, about 40% about 50%, about 60%, about 70%, about 80%, about 90%, about 95%, or all of the graphene oxide platelets may be crosslinked. In some embodiments, a majority of the graphene material may be crosslinked. The amount of crosslinking may be estimated based on the weight of the crosslinker as compared with the total amount of graphene material.

### Additives

An additive or an additive mixture may, in some instances, improve the performance of the composite. In some embodiments, the additive or additive mixture can comprise calcium chloride (CaCl₂)), a borate salt, silica nanoparticles, or any combination thereof.

Some additives or additive mixtures can comprise calcium chloride. Any suitable amount of the calcium chloride may be present in the composite. In some examples, the calcium chloride is about 5 wt % or less of the weight of the composite. In some embodiments, calcium chloride is about 0-60 wt %, about 0-1 wt %, about 0-1.5 wt %, about 0.4-1.5 wt %, about 0.4-0.8 wt %, about 0.6-1 wt %, about 0.8-1.2 wt %, about 0-1.5 wt %, about 0.1-0.2 wt %, about 0.2-0.3 wt %, about 0.3-0.4 wt %, about 0.4-0.5 wt %, about 0.5-0.6 wt %, about 0.6-0.7 wt %, about 0.7-0.8 wt %, about 0.8-0.9 wt %, about 0.9-1 wt %, about 1-1.1 wt %, about 1.1-1.2 wt %, about 1.2-1.3 wt %, about 1.3-1.4 wt %, about 1.4-1.5 wt %, about 1.5-1.6 wt %, about 0-50 wt %, about 0-40 wt %, about 0-35 wt %, or about 30 wt % of the weight of the composite, or any weight percentage in a range bounded by any of these values. Any of the above ranges which encompass about 0.8 wt % and/or 30 wt % calcium chloride are of particular interest.

In some embodiments, the additive or the additive mixture can comprise a borate salt. In some embodiments, the borate salt comprises a tetraborate salt. Examples of borate salts include K₂B₄O₇, Li₂B₄O₂, and Na₂B₄O₂. In some embodiments, the borate salt can comprise K₂B₄O₇. Any suitable amount of the borate salt may be present in the composite. In some examples, the borate salt is about 20 wt % or less of the weight of the composite. In some embodiments, the weight percentage of borate salt based upon the total weight of the composite may be in a range of about 0-20 wt %, about 0.5-15 wt %, about 4-8 wt %, about 6-10 wt %, about 8-12 wt %, about 10-14 wt %, about 1-10 wt %, about 3-4 wt %, about 4-5 wt %, about 5-6 wt %, about 6-7 wt %, about 7-7.2 wt %, about 7.2-7.5 wt %, about 7.5-8 wt %, about 8-9 wt %, about 9-9.5 wt %, about 9.5-9.8 wt %, about 9.8-10.1 wt %, about 10-11 wt %, about 11-12 wt %, about 12-13 wt %, about 13-14 wt %, about 14-16 wt %, about 16-18 wt %, about 18-20 wt %, or about any weight percentage in a range bounded by any of these values. Any of the above ranges which encompass any of the following percentages of borate salt are of particular interest: 7 wt %, 8 wt %, and 10 wt %.

The additive or the additive mixture can comprise silica nanoparticles. In some embodiments, at least one other additive (e.g., CaCl₂) and/or borate salt) is present with the silica nanoparticles. In some embodiments the silica nanoparticles may have an average size of about 5-200 nm, about 6-100 nm, about 6-50 nm, about 7-50 nm, about 2-8 nm, about 5-9 nm, about 5-15 nm, about 10-20 nm, about 15-25 nm, about 7-20 nm, about 18-22 nm, or any size in a range bounded by any of these values. The average size for a set of nanoparticles can be determined by taking the average volume and then determining the diameter associated with a comparable sphere which displaces the same volume to obtain the average size. Of particular interest are ranges recited above that encompass the following particle sizes: about 7 nm and about 20 nm.

The silica nanoparticle additive can be any suitable weight percentage of the composite. In some examples, the silica nanoparticles are about 10 wt % or less, about 0-15 wt %, about 0-10 wt %, about 0-5 wt %, about 1-10 wt %, about 0.1-3 wt %, about 2-4 wt %, about 3-5 wt %, about 4-6 wt %, or about 0-6 wt %, about 0.5-0.8 wt %, about 0.8-1.1 wt %, about 1.1-1.4 wt %, about 1.4-1.8 wt %, about 1.8-2.2 wt %, about 2.2-2.7 wt %, about 2.7-3.3 wt %, about 3.3-3.9 wt %, about 3.9-4.3 wt %, about 4.3-4.5 wt %, about 4.5-5 wt %, about 5-6 wt %, about 6-7 wt %, about 7-8 wt %, or about 8-10 wt % of the weight of the composite, or any range bounded by any of these values. Of particular interest are any ranges above that encompass any of the following values: about 1 wt %, about 2.2 wt %, and about 4.3 wt %.

### Protective Coating

Some membranes may further comprise a protective coating. For example, the protective coating can be disposed on top of the membrane to protect it from the environment. The protective coating may have any composition suitable for protecting a membrane from the environment. Many polymers are suitable for use in a protective coating such as one or a mixture of hydrophilic polymers, e.g. polyvinyl alcohol (PVA), polyvinyl pyrrolidone (PVP), polyethylene glycol (PEG), polyethylene oxide (PEO), polyoxyethylene (POE), polyacrylic acid (PAA), polymethacrylic acid (PMMA) and polyacrylamide (PAM), polyethylenimine (PEI), poly(2-oxazoline), polyethersulfone (PES), methyl cellulose (MC), chitosan, poly (allylamine hydrochloride) (PAH), and poly (sodium 4-styrene sulfonate) (PSS), and any combinations thereof. In some embodiments, the protective coating can comprise PVA.

### Methods of Making Dehydration Membranes

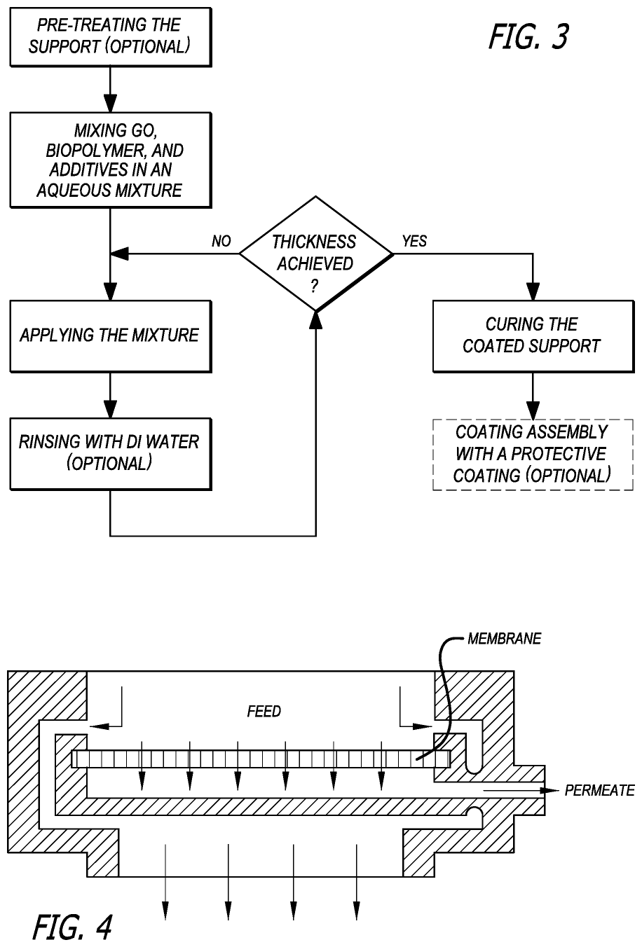

Some embodiments include methods for making the selectively permeable membrane, such as a water permeable membrane, comprising: mixing the graphene oxide compound, one or more crosslinkers (e.g. comprising a lignin, and optionally, a polyvinyl alcohol), and optionally an additive in an aqueous mixture to prepare a GO composite mixture. The mixture is applied to the porous support, repeating the application of the mixture to the porous support as necessary to obtain the desired thickness, and curing the coated support. Some methods include coating the porous support with a composite. In some embodiments, the method optionally comprises pre-treating the porous support. In some methods, a protective layer can also be placed on the membrane assembly. An example of a possible embodiment of making the aforementioned membrane is shown in FIG. 3.

In some embodiments, mixing an aqueous mixture of graphene oxide material, crosslinker (e.g. comprising a lignin, and optionally, a polyvinyl alcohol) and additives can be accomplished by dissolving appropriate amounts of graphene oxide compound, lignin (e.g., sodium lignosulfonate), polyvinyl alcohol, and additives (e.g., borate salt, calcium chloride, or silica nanoparticles) in water. Some methods comprise mixing at least two separate aqueous mixtures, e.g., (1) a graphene oxide based mixture and (2) a crosslinker and additives based mixture, then mixing appropriate mass ratios of the two mixtures together to achieve the desired results. Other methods comprise creating one aqueous mixture by dissolving appropriate amounts by mass of graphene oxide material, crosslinker(s), and additive(s) dispersed within the mixture. In some embodiments, the mixture can be agitated at temperatures and times that are sufficient to ensure uniform dissolution of the solute. The result is a mixture that can be coated onto the support and reacted to form the composite.

In some embodiments, the porous support can be pre-treated to aid in the adhesion of the composite layer to the porous support. In some embodiments, the porous support can be modified to become more hydrophilic. In some embodiments, an aqueous solution of polyvinyl alcohol can be applied to the porous support and then dried. In some examples, the aqueous solution can comprise about 0.01 wt %, about 0.02 wt %, about 0.05 wt %, about 0.1 wt %, about 0.5 wt %, about 1 wt %, about 1.5 wt %, about 2 wt %, about 3 wt %, or about 4 wt % PVA. In some embodiments, the pretreated support can be dried at a temperature of 25° C., about 50° C., about 65° C., or 75° C. for 2 minutes, 10 minutes, 30 minutes, 1 hour, or until the support is dry.

In some embodiments, applying the mixture to the porous support can be done by methods known in the art for creating a layer of desired thickness. In some embodiments, applying the coating mixture to the substrate can be achieved by vacuum immersing the substrate into the coating mixture first, and then drawing the solution onto the substrate by applying a negative pressure gradient across the substrate until the desired coating thickness can be achieved. In some embodiments, applying the coating mixture to the substrate can be achieved by blade coating, spray coating, dip coating, die coating, or spin coating. In some embodiments, the method can further comprise gently rinsing the substrate with deionized water after each application of the coating mixture to remove excess loose material. In some embodiments, the coating is done, and repeated as necessary, such that a composite layer of a desired thickness is created. The desired thickness of membrane can be in a range of about 5-2000 nm, about 10-2000 nm, about 5-1000 nm, about 1000-2000 nm, about 10-500 nm, about 500-1000 nm, about 50-400 nm, about 50-150 nm, about 100-200 nm, about 150-250 nm, about 200-300 nm, about 250-350 nm, about 300-400 nm, about 10-200 nm, about 10-100 nm, about 10-50 nm, about 20-50 nm, about 50-500 nm, or any thickness in a range bounded by any of these values. Ranges that encompass the following thicknesses are of particular interest: about 100 nm, about 200 nm, about 225 nm, and about 300 nm. In some embodiments, the number of layers can be in a range of about 1-250, about 1-100, about 1-50, about 1-20, about 1-15, about 1-10, or about 1-5. This process results in a fully coated substrate, or a coated support.

For some methods, curing the coated support can then be done at temperatures and time sufficient to facilitate crosslinking between the moieties of the aqueous mixture deposited on porous support. In some embodiments, the coated support can be heated at a temperature of about 45-200° C., about 90-170° C., or about 90-150° C. In some embodiments, the coated support can be heated for a duration of at least about 30 seconds, at least about 1 minute, at least about 15 minutes, at least about 30 minutes, at least about 1 hour, at least about 3 hours, up to about 1 hour, up to about 3 hours, up to about 5 hours, about 0.1-30 min, about 0.1-2 min, about 2-4 min, about 4-6 min, about 6-8 min, about 8-10 min, about 10-12 min, about 12-14 min, about 14-16 min, about 16-18 min, about 18-20 min, about 20-22 min, about 22-24 min, about 24-26 min, about 26-28 min, or about 28-30; with the general understanding that the time required may decrease with increasing temperatures. In some embodiments, the substrate can be heated at about 140° C. for about 1 minute or at about 90° C. for about 30 minutes. The result is a cured membrane.

In some embodiments, the method for fabricating a membrane can further comprise subsequently applying a protective coating on the membrane. In some embodiments, the applying a protective coating comprises adding a hydrophilic polymer layer. In some embodiments, applying a protective coating comprises coating the membrane with a PVA aqueous solution. Applying a protective layer can be achieved by methods such as blade coating, spray coating, dip coating, spin coating, etc. In some embodiments, applying a protective layer can be achieved by dip coating of the membrane in a protective coating solution for about 1-10 minutes, about 1-5 minutes, about 5 minutes, or about 2 minutes. In some embodiments, the method further comprises drying the membrane at a temperature of about 75-120° C. for about 5-15 minutes, or at about 90° C. for about 10 minutes. The result is a membrane with a protective coating.

### Methods for Reducing Water Vapor Content of a Gas Mixture

A selectively permeable membrane, such as the dehydration membranes described herein, may be used in methods for removing water vapor or reducing water vapor content from an unprocessed gas mixture, such as air, containing water vapor, for applications where dry gases or gases with low water vapor content are desired. The method comprises passing a first gas mixture (an unprocessed gas mixture), such as air containing water vapor, through the membrane, whereby the water vapor is allowed to pass through and removed, while other gases in the gas mixture, such as air, are retained to generate a second gas mixture (a dehydrated gas mixture) with reduced water vapor content.

A dehydrating membrane may comprise a first side of the membrane and a second side of the membrane. A dehydrating membrane may be incorporated into a device that provides a pressure gradient across the dehydrating membrane. In this way, the gas to be dehydrated (the first gas) has a higher pressure on the first side of the membrane than that of the water vapor on the second side of the dehydrating membrane where the water vapor is received, then removed, resulting in a dehydrated gas (the second gas). The dehydrated second gas is downstream of the membrane, on the first side of the membrane.

Permeated gas or a secondary dry sweep stream may be used to optimize the dehydration process. If the membrane were totally efficient in water vapor separation, all the water vapor in the feed stream would be removed, and there would be nothing left to sweep it out of the system. As the process proceeds, the partial pressure of the water vapor on the feed or bore side becomes lower, and the pressure on the shell-side becomes higher. This pressure difference tends to prevent additional water vapor from being expelled from the module. Since the objective is to make the bore side dry, the pressure difference interferes with the desired operation of the device. A sweep stream may therefore be used to remove the water vapor from the shell side, in part by absorbing some of the water vapor, and in part by physically pushing the water vapor out.

If a sweep stream is used, it may comprise an external dry source or a partial recycle of the product stream of the module. In general, the degree of dehumidification will depend on the partial pressure ratio of water vapor across the membrane and on the product recovery (the ratio of product flow to feed flow). Better membranes have a high product recovery at low levels of product humidity, and/or high volumetric product flow rates.

In some embodiments, the dehydration membrane has a water vapor transmission rate that is at least 500 g/m²/day, at least 1,000 g/m²/day, at least 1,100 g/m²/day, at least 1,200 g/m²/day, at least 1,300 g/m²/day, at least 1,400 g/m²/day, or at least 1,500 g/m²/day as determined by ASTM E96 standard method.

In some embodiments, the dehydration membrane has a gas permeance that is less than 0.001 L/m²·s·Pa, less than 10⁻⁴ L/m²·s·Pa, less than 10⁻⁵ L/m²·s·Pa, less than 10⁻⁶ L/m²·s·Pa, less than 10⁻⁷ L/m²·s·Pa, less than 10⁻⁸ L/m²·s·Pa, less than 10⁻⁹ L/m²·s·Pa, or less than 10⁻¹⁰ L/m²·s·Pa, as determined by ASTM D 1434.

The membranes described herein can be easily made at low cost and may outperform existing commercial membranes in either volumetric product flow or product recovery.

The following embodiments are specifically contemplated:

Embodiment 1. A method for dehydrating a gas comprising:

applying a first gas to the dehydration membrane, wherein the dehydration membrane comprises a porous support; and a composite coated on the porous support, the composite comprising a crosslinked graphene oxide compound, wherein the crosslinked graphene oxide compound is formed by reacting a mixture comprising a graphene oxide compound and a crosslinker comprising a lignin; and

allowing the water vapor to pass through the dehydration membrane to be removed; and

generating a second gas that has lower water vapor content than the first gas.

Embodiment 2. The method of embodiment 1, wherein the graphene oxide compound comprises graphene oxide, reduced-graphene oxide, functionalized graphene oxide, or functionalized and reduced-graphene oxide.
Embodiment 3. The method of embodiment 2, wherein the graphene oxide compound is graphene oxide.
Embodiment 4. The method of embodiment 1, 2, or 3, wherein the lignin comprises sodium lignosulfonate, calcium lignosulfonate, magnesium lignosulfonate, or potassium lignosulfonate.
Embodiment 5. The method of embodiment 1, 2, 3, or 4, wherein the crosslinker further comprises a polyvinyl alcohol.
Embodiment 6. The method of embodiment 5, wherein the weight ratio of polyvinyl alcohol to lignin is about 0 to 5.
Embodiment 7. The method of embodiment 1, 2, 3, 4, 5, or 6, wherein the composite further comprises a borate salt.
Embodiment 8. The method of embodiment 7, wherein the borate salt comprises K₂B₄O₇, Li₂B₄O₂, or Na₂B₄O₂.
Embodiment 9. The method of embodiment 7 or 8, wherein the borate salt is about 0 wt % to 20 wt % of the composite.
Embodiment 10. The method of embodiment 1, 2, 3, 4, 5, 6, 7, 8, or 9, wherein the composite further comprises CaCl₂).
Embodiment 11. The method of embodiment 10, wherein the CaCl₂) is 0 wt % to about 50.0 wt % of the composite.
Embodiment 12. The method of embodiment 1, 2, 3, 4, 5, 6, 7, 8, 9, 10, or 11, wherein the composite further comprises silica nanoparticles.
Embodiment 13. The method of embodiment 12, wherein the silica nanoparticles are 0 wt % to 10 wt % of the composite, wherein the average size of the silica nanoparticles is about 5 nm to about 200 nm.
Embodiment 14. The method of embodiment 1, 2, 3, 4, 5, 6, 7, 8, 9, 10, 11, 12, or 13, wherein the porous support is a non-woven fabric.
Embodiment 15. The method of embodiment 1, 2, 3, 4, 5, 6, 7, 8, 9, 10, 11, 12, 13, or 14, wherein the porous support comprises polyamide, polyimide, polyvinylidene fluoride, polyethylene, polypropylene, polyethylene terephthalate, polysulfone, or polyether sulfone.
Embodiment 16. The method of embodiment 15, wherein the porous support comprises polyethylene terephtha late.
Embodiment 17. The method of embodiment 1, 2, 3, 4, 5, 6, 7, 8, 9, 10, 11, 12, 13, 14, 15, or 16, having a thickness of about 10 nm to about 2000 nm.
Embodiment 18. The method of embodiment 1, 2, 3, 4, 5, 6, 7, 8, 9, 10, 11, 12, 13, 14, 15, 16, or 17, wherein the weight ratio of the crosslinker to the graphene oxide compound is about 2 to about 6.
Embodiment 19. The method of embodiment 1, 2, 3, 4, 5, 6, 7, 8, 9, 10, 11, 12, 13, 14, 15, 16, 17, or 18, wherein the composite is a layer having a thickness of about 50 nm to about 2000 nm.
Embodiment 20. The method of embodiment 1, 2, 3, 4, 5, 6, 7, 8, 9, 10, 11, 12, 13, 14, 15, 16, 17, 18, or 19, wherein the composite further contains water.

### EXAMPLES

It has been discovered that embodiments of the selectively permeable membranes described herein have improved performance as compared to other selectively permeable membranes. These benefits are further demonstrated by the following examples, which are intended to be illustrative of the disclosure, but are not intended to limit the scope or underlying principles in any way.

### Example 1.1.1: Preparation of Coating Mixture

Graphene Oxide Solution Preparation: Graphene oxide was prepared from graphite using the modified Hummers method. Graphite flakes (2.0 g) (Sigma Aldrich, St. Louis, Mo., USA, 100 mesh) were oxidized in a mixture of 2.0 g of NaNO₃ (Aldrich), 10 g KMnO₄ of (Aldrich) and 96 mL of concentrated H₂SO₄ (Aldrich, 98%) at 50° C. for 15 hours. The resulting paste like mixture was poured into 400 g of ice followed by adding 30 mL of hydrogen peroxide (Aldrich, 30%). The resulting solution was then stirred at room temperature for 2 hours to reduce the manganese dioxide, then filtered through a filter paper and washed with DI water. The solid was collected and then dispersed in DI water with stirring, centrifuged at 6300 rpm for 40 minutes, and the aqueous layer was decanted. The remaining solid was then dispersed in DI water again and the washing process was repeated 4 times. The purified graphene oxide was then dispersed in DI water under sonication (power of 10 W) for 2.5 hours to get the graphene oxide dispersion (0.4 wt %) as GO-1.

Coating Mixture Preparation: 0.4 mL of 2.5 wt % sodium lignosulfonate solution was prepared by dissolving sodium lignosulfonate (2.5 g, 51834, Spectrum Chemical) in DI water. Next, 0.1 mL of a 0.1 wt % aqueous solution of CaCl₂ (anhydrous, Aldrich) was added. Then, 0.21 mL of a 0.47 wt % of K₂B₄O₇ (Aldrich) was added and the resulting solution was stirred until mixed. The result was a crosslinker solution (XL-1). Then, GO-1 (0.5 mL) and XL-1 solutions were combined with 10 mL of DI water and sonicated for 6 minutes to ensure uniform mixing to create a coating solution (CS-1).

### Example 2.1.1: Preparation of a Membrane

Membrane Preparation: A 7.6 cm diameter PET porous support, or substrate, (Hydranautics, San Diego, Calif. USA) was dipped into a 0.05 wt % PVA (Aldrich) in DI water solution. The substrate was then dried in an oven (DX400, Yamato Scientific Co., Ltd. Tokyo, Japan) at 65° C. to yield a pretreated substrate.

Mixture Application: The coating mixture (CS-1) was then filtered through the pretreated substrate under gravity to draw the solution through the substrate such that a layer 200 nm thick of coating was deposited on the support. The resulting membrane was then placed in an oven (DX400, Yamato Scientific) at 90° C. for 30 minutes to facilitate crosslinking. This process generated a membrane (MD-1.1.1.1).

### Example 2.1.1.1: Preparation of Additional Membranes

Additional membranes were constructed using the methods similar to Example 2.1.1 with the exception that parameters were varied for the as shown in Table 1. Specifically, individual concentrations were varied, and additional additives were added to aqueous Coating Additive Solution (e.g. SiO₂ (5-15 nm, Aldrich), SiO₂ (10-20 nm, Aldrich), PVA (Aldrich)). Additionally, for some embodiments a second type of PET support (PET2) (Hydranautics, San Diego, Calif. USA) was used instead of the first type of PET support.

Where membranes were identified as coated with a dye coating instead of filtering the procedure was varied as follows. Instead of filtration the coating solution was deposited on the membrane surface using a die caster (Taku-Die 200, Die-Gate Co., Ltd., Tokyo, Japan), which was set to create the desired coating thickness.

TABLE 1
Membranes Prepared

| | | | | | Borate | Nano, | | | Thick- | Curing | |
|---|---|---|---|---|---|---|---|---|---|---|---|
| | GO | Lignin | PVA | CaCl₂ | Salt | Silica | | Coating | ness | Temp | Time |
| Membrane | (wt %) | (wt %) | (wt %) | (wt %) | (wt %) | (wt %/nm) | Support | Meth. | (nm) | (° C.) | (min) |
| MD-1.1.1.1 | 15.3 | 76.4 | — | 0.8 | 7.5 | — | PET | Filtration | 200 | 140 | 6 |
| MD-1.1.2.1 | 15.3 | 76.7 | — | 0.8 | 7.2 | — | PET2 | Filtration | 100 | 140 | 6 |
| MD-1.1.3.1 | 15.3 | 76.4 | — | 0.8 | 7.5 | — | PET2 | Filtration | 200 | 140 | 6 |
| MD-1.1.3.2 | 15.3 | 76.3 | — | 0.8 | 7.6 | — | PET2 | Filtration | 300 | 140 | 6 |
| MD-1.1.4.1 | 15.3 | 75.3 | — | 0.8 | 7.5 | 1.1/7 | PET2 | Filtration | 200 | 140 | 6 |
| MD-1.1.5.1 | 15.3 | 74.5 | — | 0.8 | 7.2 | 2.2/7 | PET2 | Filtration | 100 | 140 | 6 |
| MD-1.1.5.2 | 15.3 | 74.2 | — | 0.8 | 7.5 | 2.2/7 | PET2 | Filtration | 200 | 140 | 6 |
| MD-1.1.6.1 | 15.3 | 72.1 | — | 0.8 | 7.5 | 4.3/7 | PET2 | Filtration | 200 | 140 | 6 |
| MD-1.1.7.1 | 15.3 | 74.2 | — | 0.8 | 7.5 | 2.2/20 | PET2 | Filtration | 200 | 140 | 6 |
| MD-1.1.8.1 | 15.3 | 72.1 | — | 0.8 | 7.5 | 4.3/20 | PET2 | Filtration | 200 | 140 | 6 |
| MD-1.1.9.1 | 15.3 | 37.1 | 37.1 | 0.8 | 7.5 | 2.2/20 | PET | Filtration | 200 | 140 | 6 |
| MD-1.1.10.1 | 15.3 | 38.2 | 38.2 | 0.8 | 7.5 | — | PET | Filtration | 200 | 140 | 6 |
| MD-1.1.11.1 | 15.3 | 38.2 | 38.2 | 0.8 | 7.5 | — | PET2 | Filtration | 200 | 140 | 6 |
| MD-1.1.12.1 | 15.3 | 57.3 | 19.1 | 0.8 | 7.5 | — | PET2 | Filtration | 200 | 140 | 6 |
| MD-1.1.13.1 | 15.3 | 72.6 | 3.8 | 0.8 | 7.5 | — | PET | Filtration | 200 | 140 | 6 |
| MD-1.1.14.1 | 15.0 | 25.1 | 50.1 | — | 9.8 | — | PET2 | Die Coat | 225 | 140 | 6 |
| MD-1.1.15.1 | 15.0 | 37.6 | 37.6 | — | 9.8 | — | PET2 | Die Coat | 225 | 140 | 6 |
| MD-1.1.16.1 | 15.0 | 50.1 | 25.1 | — | 9.8 | — | PET2 | Die Coat | 225 | 140 | 6 |
| CMD-1.1.1.1 | 13.2 | — | 76.7 | — | 10.1 | — | PET2 | Die Coat | 225 | 140 | 6 |

Notes:
Numbering Scheme is MD-J.K.L.M, wherein
J = 1 - no salt rejection layer;
K = 1 - no protective coating; 2 - protective coating
L = category of membrane
M = membrane # within category

### Example 2.2.2: Preparation of a Membrane with a Protective Coating

Any of the membranes can be coated with protective layers. First, a PVA solution of 2.0 wt % can be prepared by stirring 20 g of PVA (Aldrich) in 1 L of DI water at 90° C. for 20 minutes until all granules dissolve. The solution can then be cooled to room temperature. The selected substrates can be immersed in the solution for 10 minutes and then removed. Excess solution remaining on the membrane can then be removed by paper wipes. The resulting assembly can then be dried in an oven (DX400, Yamato Scientific) at 90° C. for 30 minutes. A membrane with a protective coating can thus be obtained.

### Example 3.1: Performance Testing of Selected Membranes

Water Flux Testing: The water flux of graphene oxide-lignin based membrane coated on varies porous substrates were found to be very high, which is comparable with porous polysulfone substrate widely used in current reverse osmosis membranes.

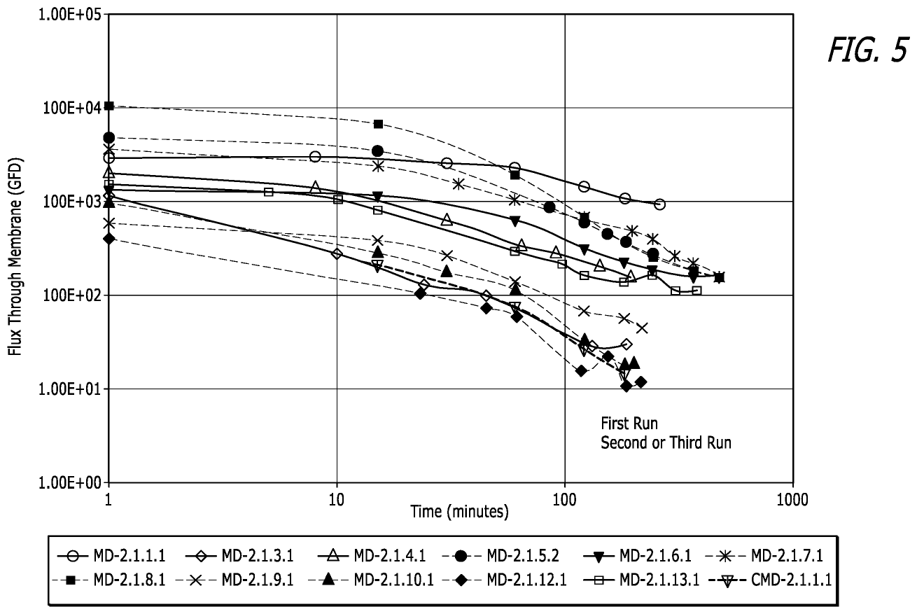

To test the mechanical strength capability, the membranes were tested by placing them into a laboratory apparatus similar to the one shown in FIG. 4. Then, once secure in the test apparatus, the membrane was then exposed to the unprocessed fluid at a gauge pressure of 50 psi. The water flux through the membrane was recorded at different time intervals to see the flux over time. The water flux was recorded at various intervals of time (e.g., 15 minutes, 60 minutes, 120 minutes, and 180 minutes) when possible. As seen in FIG. 5, most membranes showed good mechanical strength by resisting forces created by a head pressure of 50 psi while also showing a water flux better over a comparative membrane. From the data collected, it was shown that the graphene oxide-PVA-based membrane can withstand reverse osmosis pressures while providing sufficient flux.

### Example 3.1.1: Measurement of Selectively Permeable Membranes

Membranes as described in Table 1 were tested for water vapor transmission rate (WVTR) as described in ASTM E96 standard method, at a temperature of 20° C. and 100% relative humidity (RH), and/or for water vapor permeance as described in ASTM E96 standard method, at a temperature of 20° C. and 100% relative humidity (RH), and/or for N₂ permeance. Testing results are shown below in Table 2.

TABLE 2
WVTR Data

| | WVTR | N₂ Permeance |
|---|---|---|
| | (g/m² S Pa) | (L/m² s Pa) |
| MD-1.1.1.1 | 6.6 × 10⁻⁵ | 3.3 × 10⁻⁸ |
| MD-1.1.10.1 | 6.7 × 10⁻⁵ | — |
| MD-1.1.14.1 | 7.1 × 10⁻⁵ | |

Unless otherwise indicated, all numbers expressing quantities of ingredients, properties such as molecular weight, reaction conditions, and etc. used in herein are to be understood as being modified in all instances by the term “about.” Each numerical parameter should at least be construed in light of the number of reported significant digits and by applying ordinary rounding techniques. Accordingly, unless indicated to the contrary, the numerical parameters may be modified according to the desired properties sought to be achieved, and should, therefore, be considered as part of the disclosure. At the very least, the examples shown herein are for illustration only, not as an attempt to limit the scope of the disclosure.

The terms “a,” “an,” “the” and similar referents used in the context of describing embodiments of the present disclosure (especially in the context of the following claims) are to be construed to cover both the singular and the plural, unless otherwise indicated herein or clearly contradicted by context. All methods described herein may be performed in any suitable order unless otherwise indicated herein or otherwise clearly contradicted by context. The use of any and all examples, or exemplary language (e.g., “such as”) provided herein is intended merely to better illustrate embodiments of the present disclosure and does not pose a limitation on the scope of any claim. No language in the specification should be construed as indicating any non-claimed element essential to the practice of the embodiments of the present disclosure.

Groupings of alternative elements or embodiments disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability.

Certain embodiments are described herein, including the best mode known to the applicant for carrying out the embodiments. Of course, variations on these described embodiments will become apparent to those of ordinary skill in the art upon reading the foregoing description. The applicant expects skilled artisans to employ such variations as appropriate, and the applicant intends for the embodiments of the present disclosure to be practiced otherwise than specifically described herein. Accordingly, the claims include all modifications and equivalents of the subject matter recited in the claims as permitted by applicable law. Moreover, any combination of the above-described elements in all possible variations thereof is contemplated unless otherwise indicated herein or otherwise clearly contradicted by context.

In closing, it is to be understood that the embodiments disclosed herein are illustrative of the principles of the claims. Other modifications that may be employed are within the scope of the claims. Thus, by way of example, but not of limitation, alternative embodiments may be utilized in accordance with the teachings herein. Accordingly, the claims are not limited to embodiments precisely as shown and described.

1. A membrane for dehydration of a gas, comprising:
a porous support;
a composite coated on the porous support comprising a crosslinked graphene oxide compound, wherein the crosslinked graphene oxide compound is a product of reacting a mixture comprising: 1) a graphene oxide compound and 2) a crosslinker comprising a lignin; and
wherein the membrane has high moisture permeability and low gas permeability.

2. The membrane of claim 1, wherein the porous support comprises a polyamide, a polyimide, a polyvinylidene fluoride, a polyethylene, a polypropylene, a polyethylene terephthalate, a polysulfone, or a polyether sulfone.

3. The membrane of claim 2, wherein the porous support comprises a polyethylene terephthalate.

4. The membrane of claim 1, wherein the graphene oxide compound comprises graphene oxide, reduced-graphene oxide, functionalized graphene oxide, or functionalized and reduced-graphene oxide.

5. The membrane of claim 4, wherein the graphene oxide compound is graphene oxide.

6. The membrane of claim 1, wherein the lignin comprises sodium lignosulfonate, calcium lignosulfonate, magnesium lignosulfonate, or potassium lignosulfonate.

7. The membrane of claim 1, wherein the crosslinker further comprises polyvinyl alcohol, and wherein polyvinyl alcohol is crosslinked with the graphene oxide compound.

8. The membrane of claim 7, wherein the weight ratio of polyvinyl alcohol to lignin is about 5 or less.

9. The membrane of claim 1, wherein the weight ratio of crosslinker to the graphene oxide compound is about 2 to about 6.

10. The membrane of claim 1, wherein the composite further comprises a borate salt.

11. The membrane of claim 10, wherein the borate salt comprises K₂B₄O₇, Li₂B₄O₇, or Na₂B₄O₇.

12. The membrane of claim 10, wherein the borate salt is about 20 wt % or less of the composite.

13. The membrane of claim 1, wherein the composite further comprises CaCl₂.

14. The membrane of claim 13, wherein the CaCl₂ is about 5 wt % or less of the composite.

15. The membrane of claim 1, wherein the composite further comprises silica nanoparticles.

16. The membrane of claim 15, wherein the silica nanoparticles are about 10 wt % or less of the composite, and wherein the silica nanoparticles have an average size of about 3 nm to about 50 nm.

17. The membrane of claim 1, wherein the composite forms a coating on the porous support that has a thickness of about 10 nm to about 2000 nm.

18. The membrane of claim 1, wherein the composite further comprises a protective coating.

19. A method of dehydrating a gas, comprising:
a membrane of claim 1, having a first side and a second side;
introducing a first gas containing water vapor to a first side of the membrane; wherein
the water vapor pressure on the first side of the membrane is higher than the water vapor pressure on the second side of the membrane and water vapor from the first gas passes through the membrane from the first side to the second side;
wherein the retained gas is retained on the first side of the membrane to generate a second gas; and
wherein the second gas has a lower water vapor pressure than the first gas.

20. The method of claim 19, further comprising a sweep gas on the second side of the membrane that removes water vapor.
